(19) United States
(12) Patent Application Publication
(10) Pub. No.: US 2011/0276150 A1
(43) Pub. Date: Nov. 10, 2011

(54) Neural network optimizing sliding mode controller

(76) Inventors: Hussain N. Al-Duwaish, Dhahran (SA); Zakariya M. Hamouz, Dhahran (SA)

(21) Appl. No.: 12/662,888

(22) Filed: May 10, 2010

(51) Int. Cl. G05B 13/02; G06N 3/02

(52) U.S. Cl. 700/28; 706/23

(57) ABSTRACT

The neural network optimizing sliding mode controller includes an adaptive SMC that overcomes the limitations imposed on the effectiveness of the SMC under different operating conditions. Neural networks are used for on-line prediction of the optimal SMC gains when the operating point changes. The controller can be applied to a power system stabilizer (PSS) of a single machine power system. Simulation results demonstrate the effective performance of the neural network optimizing sliding mode controller.

### BACKGROUND OF THE INVENTION

1. Field of the Invention

The present invention relates generally to power generation systems, and more specifically, to a neural network optimizing sliding mode controller having a control optimization feature that improves robustness in the responses of a single power generation system under a variety of operating conditions.

2. Description of the Related Art

In recent years, there has been an ongoing interest on the application of the sliding mode controller (SMC) to different engineering problems including power systems, aerospace, robotics, and many others. The SMC is essentially a switching feedback control where the gains in each feedback path switch between two values according to some rule. The switching feedback law drives the controlled system's state trajectory onto a specified surface called the sliding surface, which represents the desired dynamic behavior of the controlled system. The advantage of switching between different feedback structures is to combine the useful properties of each structure and to introduce new properties that are not present in any of the structures used. SMC design involves finding the switching vectors representing the sliding surface and the feedback gains.

The switching vectors are very important in improving the system dynamic performance. Selection of switching vectors can be done by pole placement or linear optimal control theory. Selection of feedback gains represents the second step in SMC design. The objective of this step is to find the appropriate feedback gains that will drive the system's state trajectory to the switching surface defined by the switching vectors. Recently, artificial intelligence (Al) algorithms have been used for the selection of SMC feedback gains. Among the different search optimization methods, Genetic Algorithms (GA) have been widely used in many engineering applications. The feedback gains selection of the SMC is normally based on one operating point which results in fixed SMC gains for the entire operating points. Therefore, the performance of the controller away from the design operating point is, of necessity, a compromise. The limitations imposed on the effectiveness of the SMC by different operating conditions can be overcome by using adaptive control techniques.

Thus, a neural network optimizing sliding mode controller solving the aforementioned problems is desired.

### SUMMARY OF THE INVENTION

The neural network optimizing sliding mode controller includes an adaptive SMC that utilizes neural networks (NN) for on-line prediction of the optimal SMC gains when the operating point changes. The controller is illustrated by application to a power system stabilizer (PSS) of a single machine power system. Simulation results are included to demonstrate the performance of the controller scheme.

These and other features of the present invention will become readily apparent upon further review of the following specification and drawings.

### BRIEF DESCRIPTION OF THE DRAWINGS

FIG. 1 is a block diagram an exemplary neural network optimizing sliding mode controller according to the present invention.

FIG. 2 is a flowchart showing a genetic algorithm used with the neural network adaptive sliding mode controller according to the present invention.

FIG. 3 is a block diagram showing a neural network used to implement the neural network optimizing sliding mode controller according to the present invention.

FIG. 4 is a block diagram of the neural network optimizing sliding mode controller according to the present invention, shown in a control circuit.

FIG. 5 is a block diagram of the system under control by the neural network optimizing sliding mode controller according to the present invention.

FIG. 6 is a plot showing values of a performance index J of the neural network optimizing sliding mode controller according to the present invention.

FIG. 7 is a block diagram of the neural network optimizing sliding mode controller according to the present invention as implemented in a control circuit.

FIG. 8 is a plot showing actual vs. predicted alpha 1 (gain) values.

FIG. 9 is a plot showing actual vs. predicted alpha 2 values.

FIG. 10 is a plot showing delta omega for fixed and adaptive SMC gains.

FIG. 11 is a plot showing delta delta for fixed and adaptive SMC gains.

FIG. 12 is a plot showing the control effort for fixed and adaptive SMC gains.

Similar reference characters denote corresponding features consistently throughout the attached drawings.

### DETAILED DESCRIPTION OF THE PREFERRED EMBODIMENTS

The neural network optimizing sliding mode controller includes an adaptive SMC having neural networks for on-line prediction of the optimal SMC gains when the operating point of the system under control changes. The controller is illustrated by application to a power system stabilizer (PSS) of a single machine power system. Simulation results are included to demonstrate the performance of the controller.

It will be understood that the diagrams in the Figures depicting the neural network optimizing sliding mode controller are exemplary only, and may be embodied in a dedicated electronic device having a microprocessor, microcontroller, digital signal processor, application specific integrated circuit (ASIC), field programmable gate array, any combination of the aforementioned devices, or other device that combines the functionality of the neural network optimizing sliding mode controller onto a single chip or multiple chips programmed to carry out the method steps described herein, or may be embodied in a general purpose computer having the appropriate peripherals attached thereto and software stored on a computer readable media that can be loaded into main memory and executed by a processing unit to carry out the functionality of the controller as described herein.

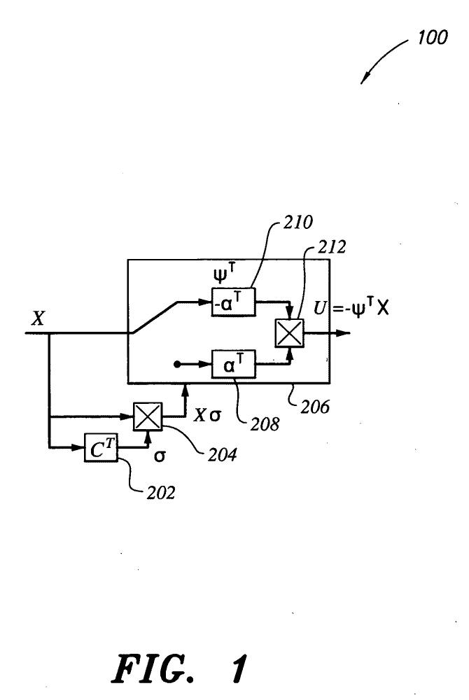

The fundamental theory of SMC is well known to persons having ordinary skill in the art. Different control goals, such as stabilization, tracking, and regulation, can be achieved using SMC by the proper design of the sliding surface. The regulation problem is addressed, wherein the objective is to keep specified states as close to zero as possible. A block diagram of the SMC 100 for the regulation problem is shown in FIG. 1. The output U 212 switches between gain values −α^{T} 210 and +α^{T} 208 based on input X, switching vectors C^{T} 202, and their product 204. The control law is a linear state feedback whose coefficients are piecewise constant functions. Consider the linear time-invariant controllable system given by:

\dot{X}(t)=AX(t)+BU(t) (1)

where

X(t) is an n-dimensional state vector;

U(t) is an m-dimensional control force vector;

A is an n×n system matrix, and

B is an n×m input matrix.

The SMC control laws for the system of (1) are given by

$${u}_{i} = - {ψ}_{i}^{T} X = - {\sum }_{j = 1}^{n} {ψ}_{ij} {x}_{j} ; i = 1 , 2 , … , m \qquad ( 2 )$$

where the feedback gains are given as:

$${ψ}_{ij} = \{ \begin{matrix}{α}_{ij} , & if {x}_{i} {σ}_{j} > 0 \\ - {α}_{ij} , & if {x}_{j} {σ}_{i} < 0\end{matrix} i = 1 , … , m ; j = 0 , … , n \\ and \\ {σ}_{i} ( X ) = {C}_{i}^{T} X = 0 , i = 1 , … , m \qquad ( 3 )$$

where Cᵢ's are the switching vectors, which are selected by pole placement or linear optimal control theory.

The design procedure for selecting the constant switching vectors cᵢ using pole placement includes a procedure that defines the coordinate transformation:

Y=MX (4)

such that:

$$MB = [ \begin{matrix}0 \\ … \\ {B}_{2}\end{matrix} ] \qquad ( 5 )$$

where M is a nonsingular n×n matrix and B₂ is a nonsingular m×m matrix. Then, from (4) and (5) calculating;

$$\begin{matrix}\dot{Y} = M \dot{X} = {MAM}^{- 1} Y + MBU & ( 6 ) \\ [ \begin{matrix}{\dot{Y}}_{1} \\ {\dot{Y}}_{2}\end{matrix} ] = [ \begin{matrix}{A}_{11} & {A}_{12} \\ {A}_{21} & {A}_{22}\end{matrix} ] [ \begin{matrix}{Y}_{1} \\ {Y}_{2}\end{matrix} ] + [ \begin{matrix}0 \\ {B}_{2}\end{matrix} ] U & ( 7 )\end{matrix}$$

where A₁₁, A₁₂, A₂₁, A₂₂ are respectively (n−m)×(n−m), (n−m)×m, m×(n−m) and (m×m) submatrices. The first equation of (7) together with (3) specifies the motion of the system in the sliding mode, which is:

\dot{Y}₁=A₁₁Y₁+A₁₂Y₂ (8)

Σ(Y)=C₁₁Y₁+C₁₂Y₂ (9)

where C₁₁ and C₁₂ are m×(n−m) and (m×m) matrices, respectively, satisfying the relation

[C₁₁C₁₂]=C^{T}M⁻¹ (10)

Equations (8) and (9) uniquely determine the dynamics in the sliding mode over the intersection of the switching hyper-planes.

The subsystem described by (8) may be regarded as an open loop control system with state vector Y₁ and control vector Y₂ being determined by (9), that is

Y₂=C₁₂⁻¹C₁₁Y₁ (11)

Consequently, the problem of designing a system with desirable properties in the sliding mode can be regarded as a linear feedback design problem. Therefore, it can be assumed, without loss of generality, that c₁₂=an identity matrix of proper dimension. Next, equations (8) and (11) can be combined to obtain

\dot{Y}₁=[A₁₁−A₁₂C₁₁]Y₁ (12)

It is well know in the art that if the pair (A, B) is controllable, then the pair (A₁₁,A₁₂) is also controllable. If the pair (A₁₁,A₁₂) is controllable, then the eigenvalues of the matrix [A₁₁−A₁₂C₁₁] in the sliding mode can be placed arbitrarily by suitable choice of C₁₁. The feedback gains αᵢⱼ are usually determined by simulating the control system and trying different values until satisfactory performance is obtained.

The neural network optimizing SMC involves the following steps: (1) generating data for the SMC gains that correspond to different operating points using genetic algorithms; (2) training and testing of the neural network to perform the nonlinear mapping between the operating points and SMC feedback gains; and (3) online implementation of the SMC.

Genetic algorithms are directed random search techniques that can find the global optimal solution in complex multidimensional search spaces. GA employs different genetic operators to manipulate individuals in a population of solutions over several generations to improve their fitness gradually. Normally, the parameters to be optimized are represented in a binary string. To start the optimization, GA uses randomly produced initial solutions created by a random number generator. This method is preferred when a priori knowledge about the problem is not available.

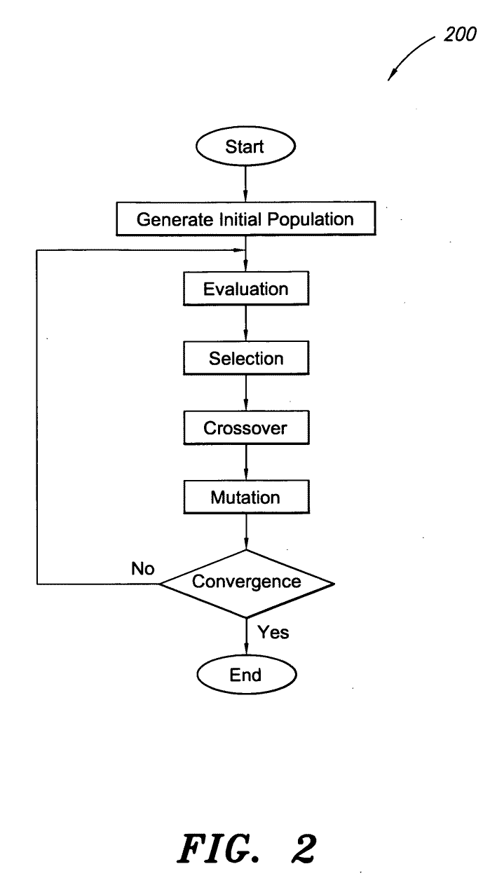

The flowchart of a simple GA procedure 200 is shown in FIG. 2. There are basically three genetic operators used to generate and explore the neighborhood of a population and select a new generation. These operators are selection, crossover, and mutation. After randomly generating the initial population of, e.g., N solutions, the GA uses the three genetic operators to yield N new solutions at each iteration. In the selection operation, each solution of the current population is evaluated by its fitness, normally represented by the value of some objective function, and individuals with higher fitness value are selected. Different selection methods, such as stochastic selection or ranking-based selection, can be used.

The crossover operator works on pairs of selected solutions with certain crossover rate. The crossover rate is defined as the probability of applying crossover to a pair of selected solutions. There are many ways of defining this operator. The most common way is called the one-point crossover, which can be described as follows. Given two binary-coded solutions of certain bit length, a point is determined randomly in the two strings, and corresponding bits are swapped to generate two new solutions. Mutation is a random alteration with small probability of the binary value of a string position. This operation will prevent the GA from being trapped in a local minimum. The fitness evaluation unit in the flowchart acts as an interface between the GA and the optimization problem. Information generated by this unit about the quality of different solutions is used by the selection operation in the GA. The algorithm is repeated until a predefined number of generations have been produced.

The GA is used to generate SMC feedback gains for different operating points in the following manner: (1) generate randomly a set of possible feedback gains; (2) evaluate a performance index when the system is subjected to a change in the operating point for all possible feedback gains generated in step 1; (3) use genetic operators (selection, crossover, mutation) to produce a new generation of feedback gains; (4) evaluate the performance index in step 2 for the new generation of feedback gains. Stop if there is no more improvement in the value of the performance index, or if a certain predetermined number of generation has been used. Otherwise, go to step (3).

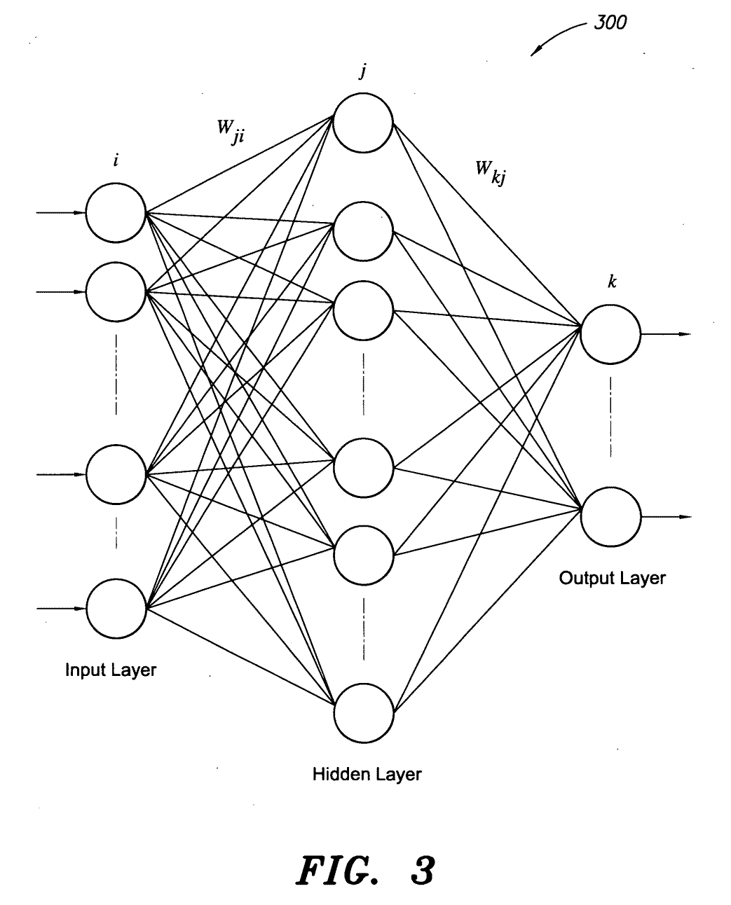

A multilayer neural network is a layered network consisting of an input layer, an output layer, and one or more hidden layers. Each layer includes a set of neurons, which are fully connected to the neurons in the next layer. The connections have multiplying weights associated with them. The number of neurons and hidden layers is problem-dependent. However, it has been proved that one hidden layer can perform any nonlinear mapping, and no more than two hidden layers are needed. As shown in FIG. 3, a multilayer feedforward neural network 300 having a single hidden layer is used for the neural network optimizing sliding mode controller.

The connection weights between the neurons and thresholds are determined using the generalized delta rule. The process of determining the weights is called the training or learning process. The training process requires a set of input and output patterns. The patterns are fed into the neural networks. The neurons in the input layer receive input signals. Then, the resultant activation signals propagate forward through the hidden layer(s) to the output layer. The output layer then gives the desired output. The network learns by comparing its output of each input pattern with the actual output of that pattern. The error (the difference between the actual outputs and the predicted outputs of the network) is calculated and propagated backwards from the output to the hidden layer to the input. This is done by minimizing the error function:

$$E = {\sum }_{p} {E}_{p} = \frac{1}{2} {\sum }_{p} {\sum }_{k} {( {t}_{k}^{( p )} - {y}_{k}^{( p )} )}^{2} \qquad ( 13 )$$

where tₖ is the actual output and yₖ is the predicted output of the neural network. The inputs to the neural network used for the adaptive SMC corresponds to the system operating points, while the outputs generated by the NN represent the SMC feedback gains. The training of the NN is performed using the data generated by the GA. Normally, the data is divided into two parts; one for training and the other for testing.

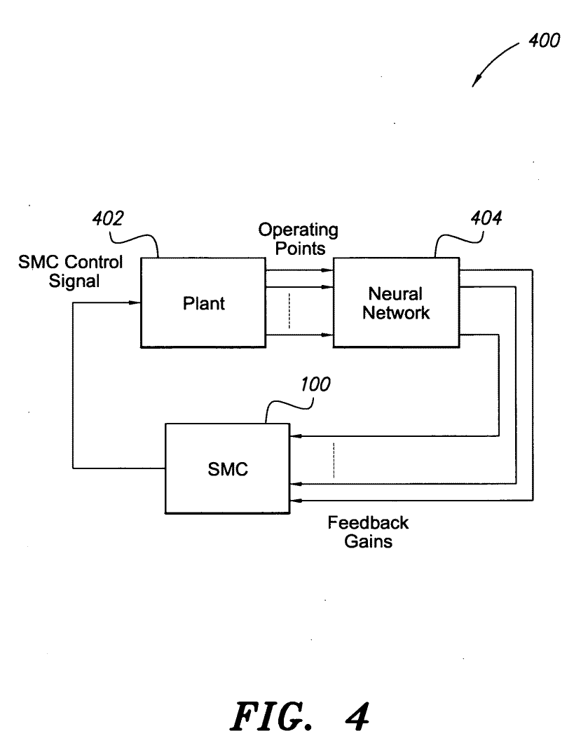

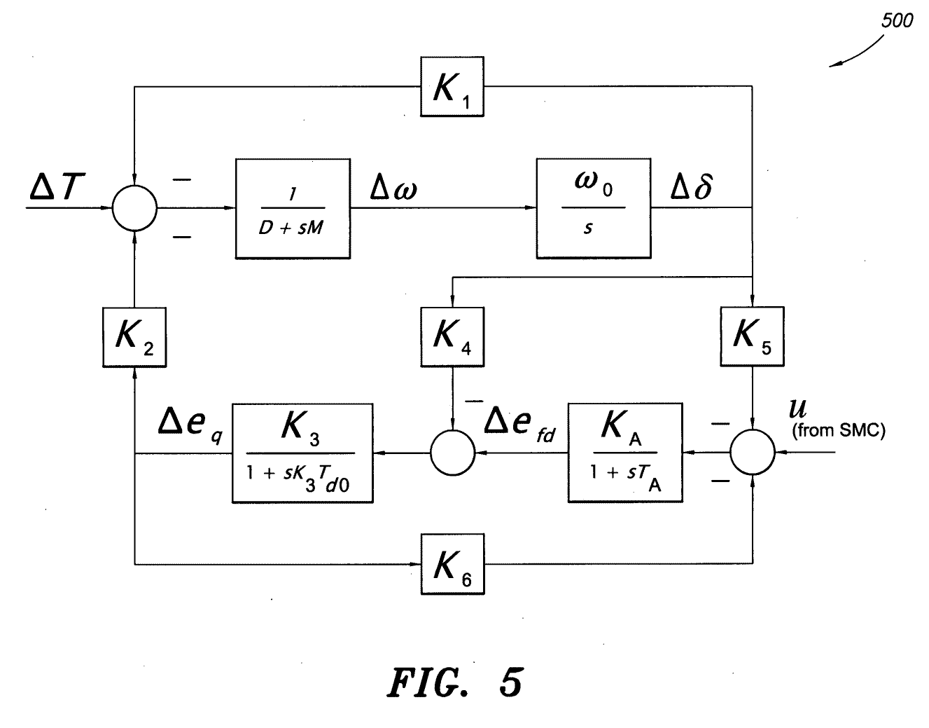

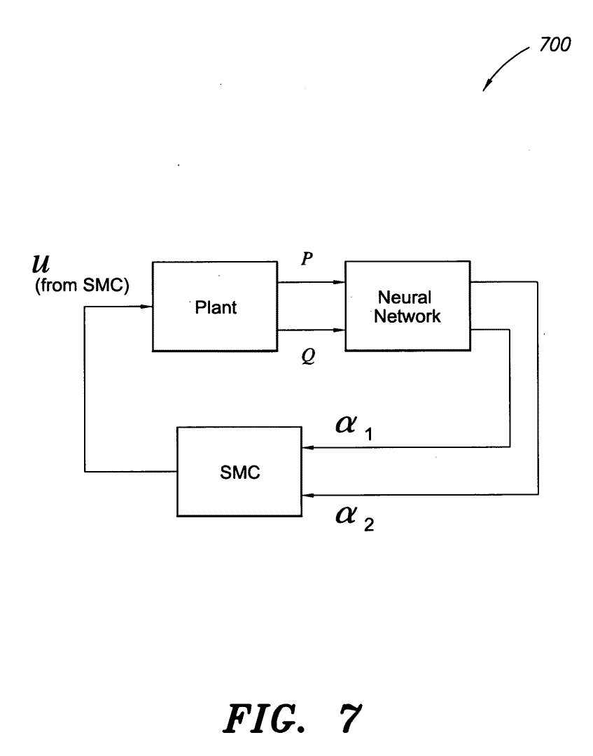

As shown in FIG. 4, the neural network optimizing SMC can be applied to a plant under control 402 having a plurality of operating points, which feed the inputs of a neural network 404. Outputs of the neural network 404 are utilized as feedback gains fed to the SMC 100. The SMC 100 then feeds a control signal back to the plant under control 402. The plant under control 500 is most clearly shown in FIG. 5. Set points P and Q, and feedback gains α₁ and α₂, are most clearly detailed in system configuration 700, as shown in FIG. 7. As the operating point changes, the neural network adaptively produces new feedback gains optimally suitable for the new operating point.

The neural network optimizing sliding mode controller is applied to the design of a power system stabilizer (PSS) of a single machine power system model 500, where the system model is a function of the operating point defined by active and reactive powers (P, Q). The need for adaptive SMC comes from the fact that the model 500 operates over a wide range of operating points, some of which are unstable. Thus, no single SMC with fixed feedback gains is sufficient for the entire operation. The system under control 500 is a linearized power system model for low-frequency oscillation studies. The dynamic model in state-variable form can be obtained from the transfer function model and is given as:

$$\dot{X} ( t ) = AX ( t ) + Bu ( t ) + Fd ( t )$$

$$where$$

$$X ( t ) = {[ \begin{matrix}Δ ω ( t ) & Δ δ ( t ) & {Δe}_{q}^{′} ( t ) & Δ {e}_{jd} ( t )\end{matrix} ]}^{T} , \\ u ( t ) = {u}_{( from SMC )} , d ( t ) = Δ {T}_{m} ( t )$$

$$A = [ \begin{matrix}- \frac{D}{M} & - \frac{{K}_{1}}{M} & - \frac{{K}_{2}}{M} & 0 \\ {ω}_{0} & 0 & 0 & 0 \\ 0 & - \frac{{K}_{4}}{{T}_{d 0}^{′}} & - \frac{1}{{T}_{d 0}^{′} {K}_{3}} & \frac{1}{{T}_{d 0}^{′}} \\ 0 & - \frac{{K}_{4} {K}_{5}}{{T}_{A}} & - \frac{{K}_{4} {K}_{6}}{{T}_{A}} & - \frac{1}{{T}_{A}}\end{matrix} ]$$

$$B = {[ \begin{matrix}0 & 0 & 0 & \frac{{K}_{A}}{{T}_{A}}\end{matrix} ]}^{T}$$

$$F = {[ \begin{matrix}\frac{1}{M} & 0 & 0 & 0\end{matrix} ]}^{T}$$

ω is the rotor speed (rad/sec), δ is the machine shaft angular displacement (degree), D is the damping coefficient, M is the inertia constant, e_{q}′ is the voltage proportional to the field flux linkages of machine, e_{fd} is the generator field voltage, K₁-K₆ are constants of the linearized model, K_{A} is the automatic voltage regulator gain, T_{A} is the automatic voltage regulator time constant (sec), T_{do}′ d-axis transient open circuit time constant. The control objective in the PSS problem is to keep the change in frequency (Δω) as close to zero as possible when the operating point changes by manipulating the input (u). For this plant, the pair (A, B) has been found to be controllable.

Following the aforementioned GA design procedure, crossover and mutation probabilities, as well as population size of 0.7, 0.001, and 35, are used to get the optimal SMC gains (α₁ and α₂) corresponding to different operating points in the range (P from 0.1 to 1 p.u and Q from −1 to 1 per/unit (p.u)). The performance index given by:

$$J = {\int }_{0}^{∞} Δ {ω}^{2} ( t ) d t$$

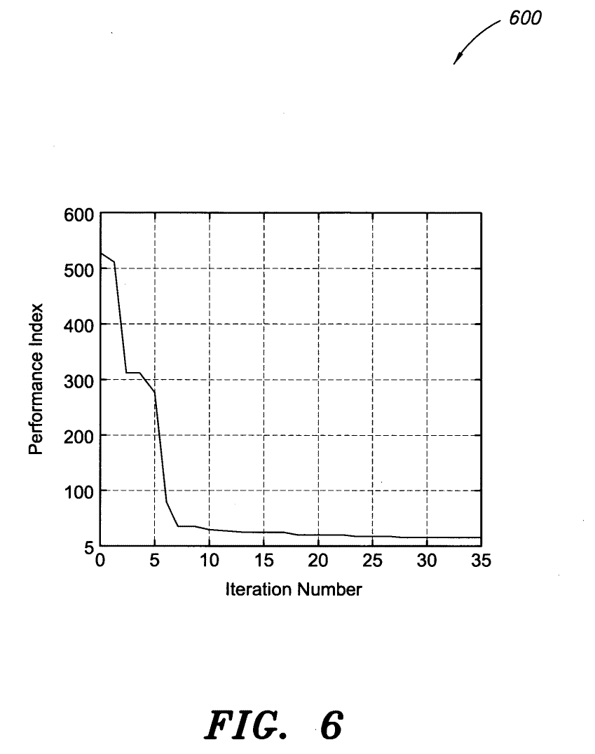

is minimized using GA. The minimization of this performance index keeps the change in frequency (Δω) as close to zero as possible, regardless of the operating point. The plot 600, shown in FIG. 6, illustrates the behavior of the performance index, where it can be seen that the convergence is very fast. During the NN training process, two hundred ten operating points generated by changing P from 0.1 to 1.0 (per unit) and Q from −1 to 1 (per unit), which represent the practical operating range of the studied system 500, are used.

The change has been made in steps of 0.1. In practice, any step change can take place. The neural network used has two inputs (P, Q), two outputs (α₁ and α₂), and 30 neurons in the hidden layer. The online implementation of the adaptive SMC is most clearly shown as system configuration 700 in FIG. 7. When the operating point (P, Q) changes, the trained neural network adaptively produces new feedback gains α₁ and α₂ suitable for this new operating point.

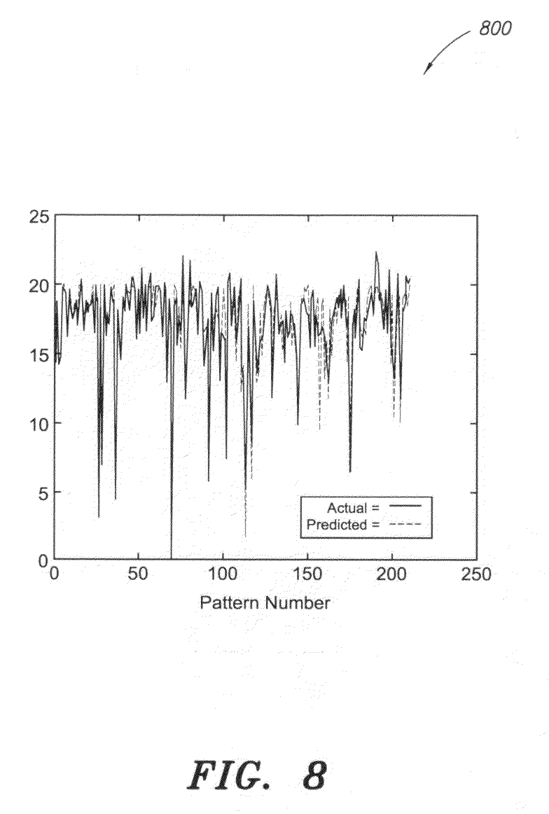

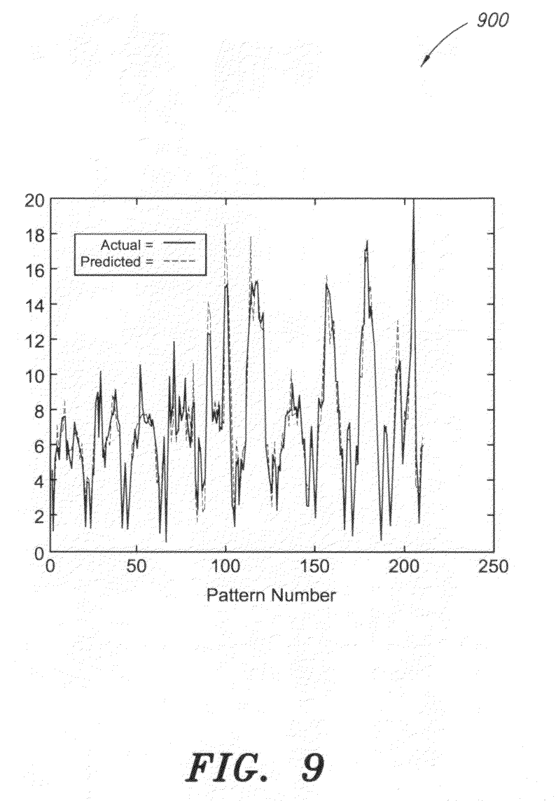

The results of training and testing the neural network are shown as plots 800 and 900 of FIGS. 8 and 9, respectively. The first 80 percent of data were used for training and the remaining 20 percent were used for testing of the neural network. Findings indicate good agreement between the actual feedback gains (generated by the GA) and outputs of the neural network.

For the operating point of (P=0.1, Q=1.0), a fixed variable structure controller for the above system has been designed. To reduce the complexity of the SMC, the two states Act) and LIS are used for feedback. The switching vector used is:

C=[−30000 −97.2134 107.0026 1]^{T}

and the feedback gains obtained using genetic algorithms are:

α₁=18.5109 and α₂=4.2116.

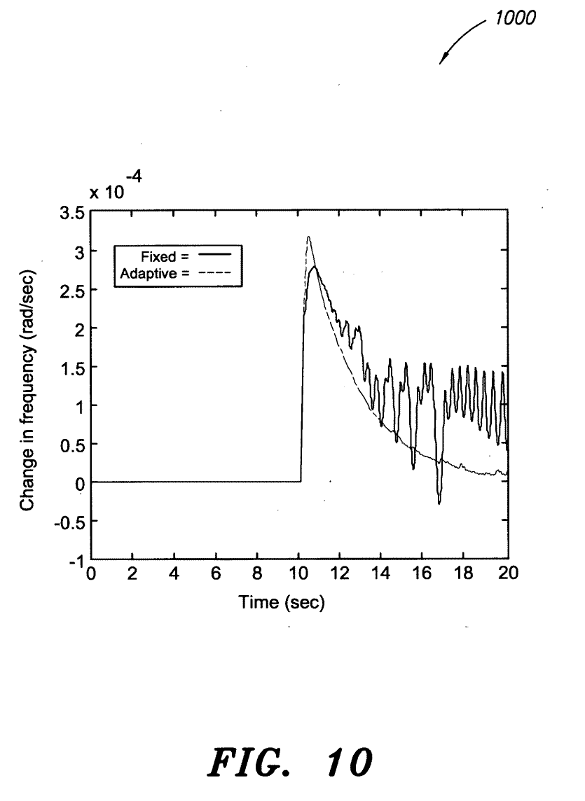

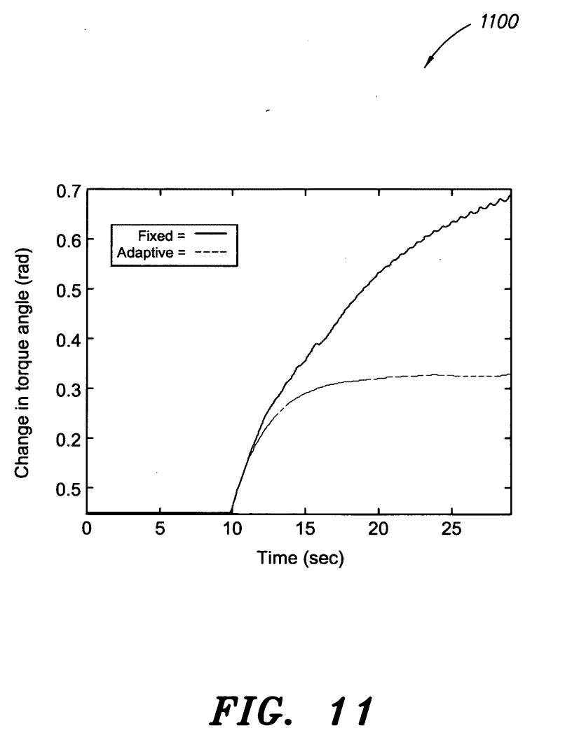

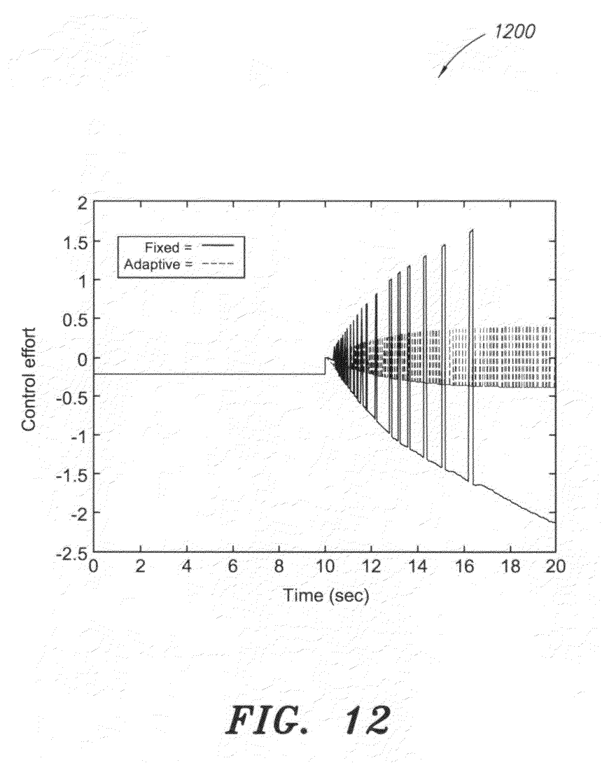

As shown in FIG. 10, the simulation results plot 1000 details the change in frequency (Δω) when the operating point of the systems changes from (P=0.1, Q=1.0) to (P=0.3, Q=−0.9) at time 10 seconds, which has not been used in the training set. Plot 1000 demonstrates the effectiveness of the adaptive SMC in damping the frequency oscillations. As shown in FIG. 11, plot 1100 shows the change in the torque angle when using the fixed and adaptive SMC. It is quite clear that the adaptive SMC drives the torque angle to its steady state value much faster than the fixed SMC. As shown in FIG. 12, plot 1200 illustrates the control efforts of the fixed and adaptive SMC gains. Plot 1200 clearly demonstrates the lower control effort needed for the case of adaptive SMC gains.

A neural network optimizing sliding mode controller has been developed for a PSS of a single machine power system. The use of adaptive output feedback is motivated by the fact that the single machine power system operates over a wide range of operating conditions, and, hence, no single SMC gains are sufficient for the entire operation. The neural network is used to adaptively predict the suitable SMC gains for any operating point. The training data for the neural network has been generated using genetic algorithms. Simulation results indicate that the adaptive, neural network optimizing sliding mode controller greatly improves upon performance found in fixed sliding mode controllers.

It is to be understood that the present invention is not limited to the embodiment described above, but encompasses any and all embodiments within the scope of the following claims.

We claim:

1. A neural network optimizing sliding mode controller, comprising:
a sliding mode controller having a plurality of feedback gain inputs and a control signal output, the control signal output being adapted for connection to a control input of a circuit under control;
a neural network having an input layer having a plurality of neural network inputs, an output layer having a plurality of neural network outputs, and a hidden layer operably connected to the input layer and to the output layer, the neural network inputs being adapted for connection to operating point outputs of the circuit under control, the neural network outputs being connected to the feedback gain inputs of the sliding mode controller, the neural network having weights adjustably compatible with a predetermined range of the operating point outputs of the circuit under control, thereby resulting in optimum feedback gain constants being provided by the neural network to the feedback gain inputs of the sliding mode controller, the feedback gain constants being provided according to a nonlinear mapping of the feedback gain constants to the operating point outputs as the operating points are changed.

2. The neural network optimizing sliding mode controller according to claim 1, further comprising means for training said neural network resulting in said nonlinear mapping between the feedback gain constants and the operating points of the circuit under control, the optimum feedback gain constants being generated by said neural network.

3. The neural network optimizing sliding mode controller according to claim 2, wherein said means for training said neural network comprises a processor executing a genetic algorithm, the processor generating sets of possible feedback gains under varying operating points, the sets of possible feedback gains being subject to a fitness function used by the genetic algorithm, a most fit of the possible feedback gains being used by said neural network to determine the nonlinear mapping of the feedback gains to the operating points.

4. The neural network optimizing sliding mode controller according to claim 3, wherein the circuit under control is an electrical power generation system having a single prime mover, said neural network optimizing sliding mode controller functioning as a power system stabilizer for the electrical power generation system.

5. The neural network optimizing sliding mode controller according to claim 4, further comprising means for minimizing frequency deviation of the single prime mover under varying load conditions and operating points of the electrical power generation system.

6. The neural network optimizing sliding mode controller according to claim 5, wherein the fitness function is characterized by a performance index,
$$J = {\int }_{0}^{∞} Δ {ω}^{2} ( t ) d t ,$$
the performance function, when minimized, keeping the change in frequency (Δω) as close to zero as possible regardless of the operating point of the electrical power generation system.

7. A neural network optimizing sliding mode controller, comprising:
a sliding mode controller having a plurality of feedback gain inputs and a control signal output, the control signal output being adapted for connection to a control input of an electrical power generation system having a single prime mover, the neural network optimizing sliding mode controller functioning as a power system stabilizer for the electrical power generation system;
a neural network having an input layer having a plurality of neural network inputs, an output layer having a plurality of neural network outputs, and a hidden layer operably connected to the input layer and to the output layer, the neural network inputs being adapted for connection to operating point outputs of the electrical power generation system, the neural network outputs being connected to the feedback gain inputs of the sliding mode controller, the neural network having weights adjustably compatible with a predetermined range of the operating point outputs of the electrical power generation system, thereby resulting in optimum feedback gain constants being provided by the neural network to the feedback gain inputs of the sliding mode controller, the feedback gain constants being provided according to a nonlinear mapping of the feedback gain constants to the operating point outputs as the operating points are changed.

8. An electrical power generation system control method, comprising the step of:
operably connecting a sliding mode controller to an electrical power generation system, the sliding mode controller having a control signal output adapted for connection to the control input of the electrical power generation system, a plurality of feedback gain inputs, the sliding mode controller including a neural network having an input layer having a plurality of neural network inputs, an output layer having a plurality of neural network outputs, and a hidden layer operably connected to the input layer and to the output layer, the neural network inputs being adapted for connection to operating point outputs of the electrical power generation system, the neural network outputs being connected to the feedback gain inputs of the sliding mode controller, the neural network having weights adjustably compatible with a predetermined range of the operating point outputs of the electrical power generation system, thereby resulting in optimum feedback gain constants being provided by the neural network to the feedback gain inputs of the sliding mode controller, the feedback gain constants being provided according to a nonlinear mapping of the feedback gain constants to the operating point outputs as the operating points are changed.

9. The electrical power generation system control method according to claim 8, further comprising the step of training said neural network to provide the nonlinear mapping between the feedback gain constants and the operating points of the electrical power generation system, the optimum feedback gain constants being generated by said neural network.

10. The electrical power generation system control method according to claim 9, further comprising the step of running a genetic algorithm to generate sets of possible feedback gains under varying operating points, the sets of possible feedback gains being subject to a fitness function used by the genetic algorithm, a most fit of the possible feedback gains being used by said neural network to determine the nonlinear mapping of the feedback gains to the operating points.

11. The electrical power generation system control method according to claim 10, further comprising the step of minimizing frequency deviation of the electrical power generation system under varying load conditions and operating points of the electrical power generation system.

12. The electrical power generation system control method according to claim 11, wherein the fitness function is characterized by a performance index,
$$J = {\int }_{0}^{∞} Δ {ω}^{2} ( t ) d t ,$$
the performance index, when minimized, keeping the change in frequency (Δω) as close to zero as possible regardless of the operating point of the electrical power generation system.
